(19) United States
(12) Patent Application Publication
(10) Pub. No.: US 2023/0264321 A1
(43) Pub. Date: Aug. 24, 2023

(54) CROWNING FILE FOR USE IN FILING FRETS OF A STRINGED INSTRUMENT

(71) Applicant: Music Nomad, LLC, Sonoma, CA (US)

(72) Inventors: Rand Rognlien, Sonoma, CA (US); Pieter Schouten, Berkeley, CA (US); Jonathan Jones, Sonoma, CA (US); Robert Geoffrey Luttrell, Petaluma, CA (US)

(73) Assignee: Music Nomad, LLC, Sonoma, CA (US)

(21) Appl. No.: 18/113,478

(22) Filed: Feb. 23, 2023

Related U.S. Application Data
(60) Provisional application No. 63/312,937, filed on Feb. 23, 2022.

(51) Int. Cl. B24D 15/02

(52) U.S. Cl. CPC B24D 15/02; G10D 3/06

(57) ABSTRACT

A file for filing a fret of a stringed instrument includes a filing slot with two radiused side regions that are coated with abrasive material and a central crown region that is non-abrasive. Sliding the filing slot back and forth across a fret will file away material using the radiused sides. Once the non-abrasive crown region touches the fret the filing motion can cease, and the fret will be appropriately crowned without over-filing.

### CROSS-REFERENCE TO RELATED APPLICATION

This application claims priority to U.S. Provisional Patent Application Ser. No. 63/312,937, filed on Feb. 23, 2022, and entitled “A radiused fret crowning file with a center safety strip that prevents over filing of the fret,” the entire disclosure of which is incorporated herein by reference.

### FIELD OF THE INVENTION

The present disclosure is directed generally to files used in connection with filing frets of a stringed instrument.

### BACKGROUND

Guitar and bass frets are difficult to crown and are often over-filed by technicians. A standard fret crowning file allows a technician to file a fret too low, ruining the instrument's fret job. Other files allow the operator to file a fret well beyond the top of the fret, which lowers the fret top in relation to the other frets. This ruins the fret job on the instrument. Even experienced techs struggle with the correct usage of existing files, and this invention solves that problem.

Accordingly, there is a need in the art for a fret file that prevents over-filing of a fret by a technician.

### SUMMARY

The present disclosure is directed to a radiused fret crowning file with a center safety strip that prevents over filing of the fret. In essence, the file includes a safety strip of plain metal or plastic (importantly the center area is non-abrasive) at the top of the cutting material, causing the file to stop cutting when the fret top is reached. This allows any user to correctly crown a fret without risk of overfilling.

According to an aspect is a file for use in filing a strip of metal, comprising an elongated body having a first filing edge that extends along a first longitudinal axis; and a first filing slot formed in the first filing edge and comprising a pair of edges that extend along the intersection of the first filing slot and the elongated body, a crown portion having first and second sides and that is positioned along the longitudinal axis and at the deepest portion of the first filing slot, and first and second side portions that extend from the first and second sides of the crown portion, respectively, to the respective edges of the first filing slot; wherein the first and second side portions contain an abrasive material adapted for filing the strip of metal and the crown portion does not include abrasive material thereon.

According to an embodiment, the first filing slot is concave in shape.

According to an embodiment, the first filing slot extends at a first oblique angle outwardly from the first longitudinal axis and terminates in a first rounded nose.

According to an embodiment, the elongated body further comprises a second filing edge that extends along a second longitudinal axis, and a second filing slot formed in the second filing edge and comprising a pair of edges that extend along the intersection of the second filing slot and the elongated body, a crown portion having first and second sides and that is positioned along the second longitudinal axis and at the deepest portion of the second filing slot, and first and second side portions that extend from the first and second sides of the crown portion, respectively, to the edges of the second filing slot; wherein the first and second side portions are coated with abrasive material adapted for filing the strip of metal and the crown portion does not include abrasive material thereon.

According to an embodiment, the first longitudinal axis and second longitudinal axis are in spaced parallel relation to one another.

According to an embodiment, the first filing slot and second filing slot are of predetermined widths that are different from one another.

According to an embodiment, the second filing slot extends at a second oblique angle from the second longitudinal axis and terminates in a second rounded nose.

According to an aspect is a method for using a file to file a strip of metal, comprising the steps of providing a file having a filing slot that includes two sides of filing material coating formed thereon and a central, crown portion that is uncoated; sliding the file back and forth across the strip of metal; and stopping the sliding movement once the central, crown portion touches the strip of metal.

According to an aspect is a file for filing a strip of metal, comprising a body with a first slotted filing region of predetermined depth formed therein and having a first crown portion at its deepest part and first and second radiused side regions extending outwardly from the first crown region; and abrasive material formed on each of the first and second radiused side regions and non-abrasive material forming the first crown portion.

According to an embodiment, the filing region is concave in shape.

According to an embodiment, the file further comprises a second slotted filing region of predetermined depth formed in the body and having a second crown portion at its deepest part and third and fourth radiused side regions extending outwardly from the second crown region; and abrasive material formed on each of the third and fourth radiused side regions and non-abrasive material forming the second crown portion.

According to an embodiment, the first and second slotted filing regions are or predetermined width that are different from one another.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a first perspective view of a file for use in filing frets of a stringed instrument, in accordance with an embodiment.

FIG. 2 is a second perspective view of a file for use in filing frets of a stringed instrument, in accordance with an embodiment.

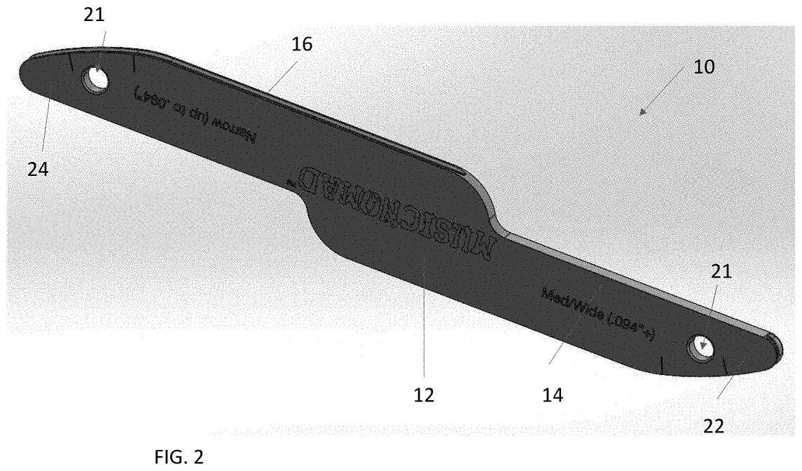

FIG. 3 is a side elevation view of a file for use in filing frets of a stringed instrument, in accordance with an embodiment.

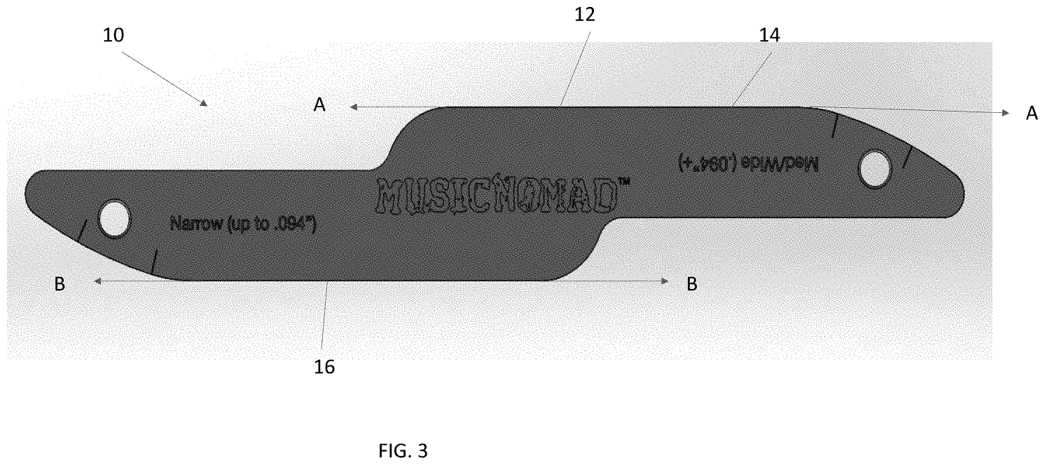

FIG. 4 is a partial perspective view of a file for use in filing frets of a stringed instrument, in accordance with an embodiment.

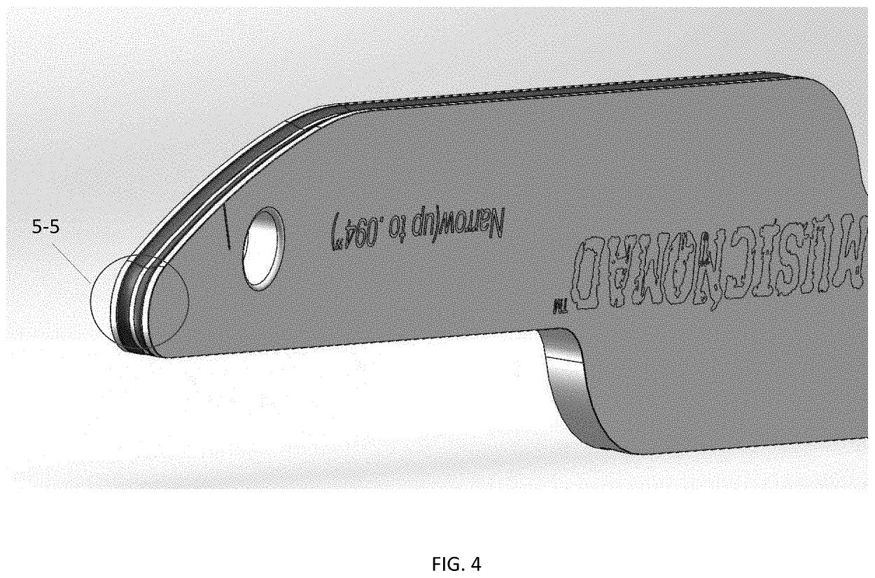

FIG. 5 is a partial sectional view taken from section 5-5 of FIG. 4, in accordance with an embodiment.

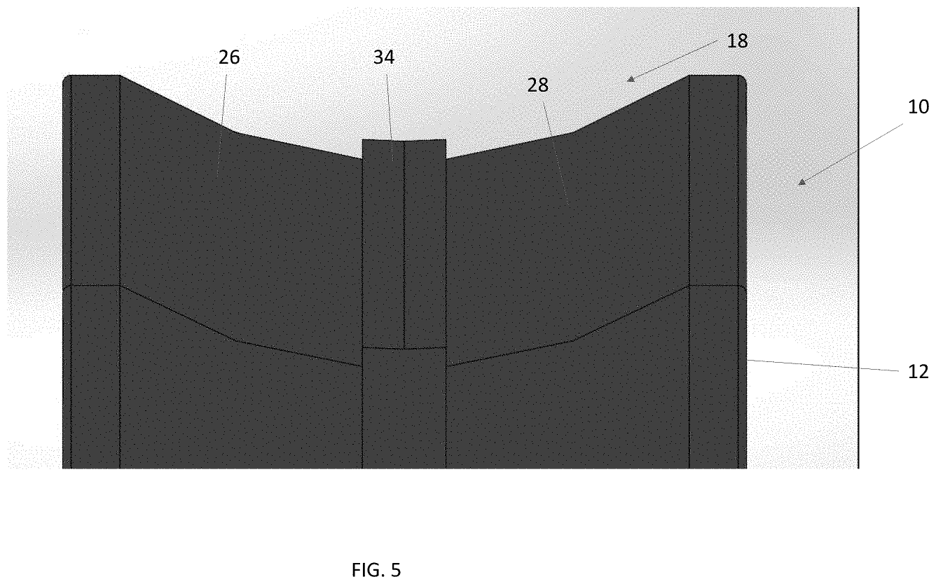

FIG. 6 is a top plan view of a file for use in filing frets of a stringed instrument, in accordance with an embodiment.

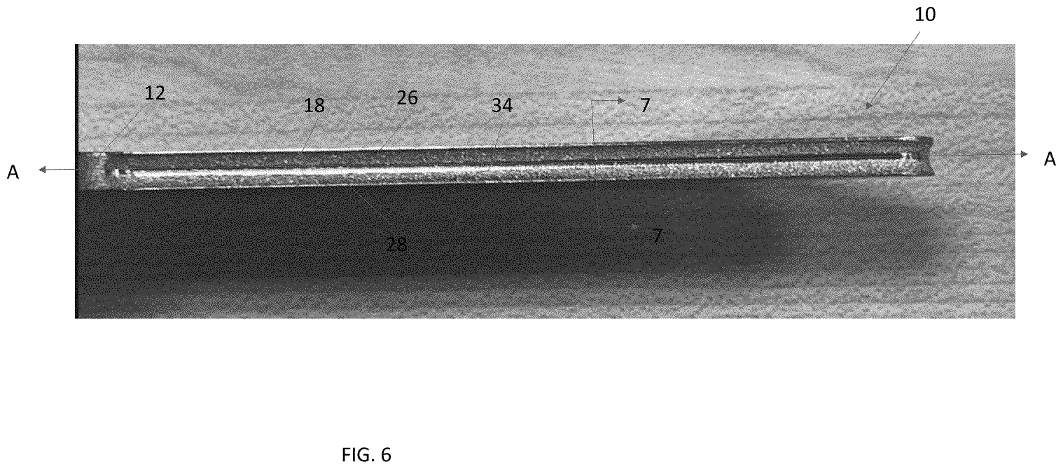

FIG. 7 is a cross-sectional view taken along section line 7-7 of FIG. 6, in accordance with an embodiment.

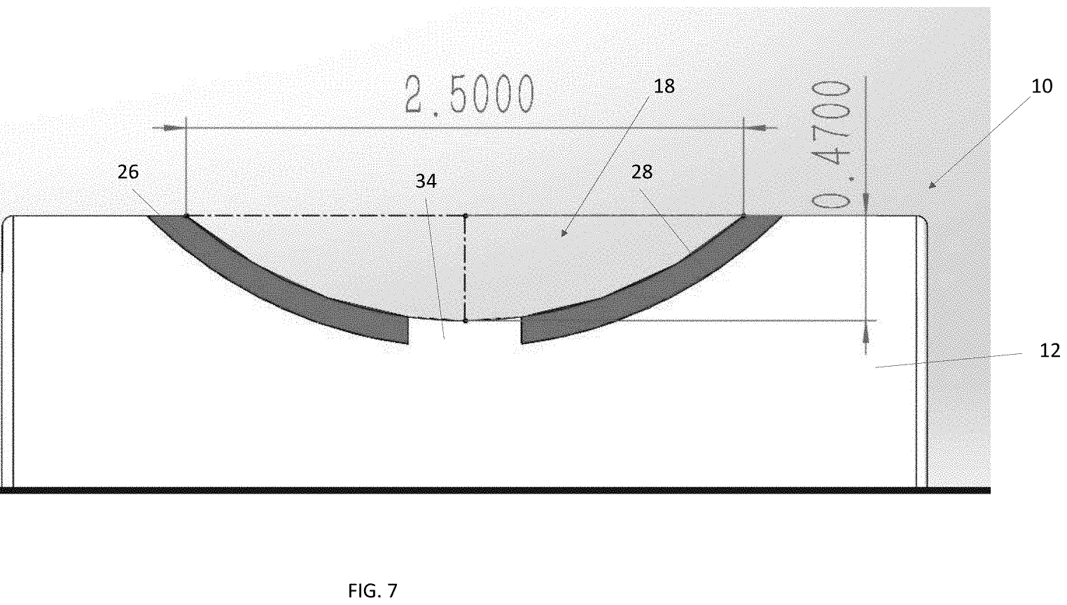

FIG. 8 is a perspective view of a file for use in filing frets of a stringed instrument, in accordance with an embodiment.

FIG. 9 is a cross-sectional view taken along section line 9-9 of FIG. 8, in accordance with an embodiment.

### DETAILED DESCRIPTION OF EMBODIMENTS

The present disclosure describes a radiused fret crowning file with a center safety strip that prevents over filing of the fret.

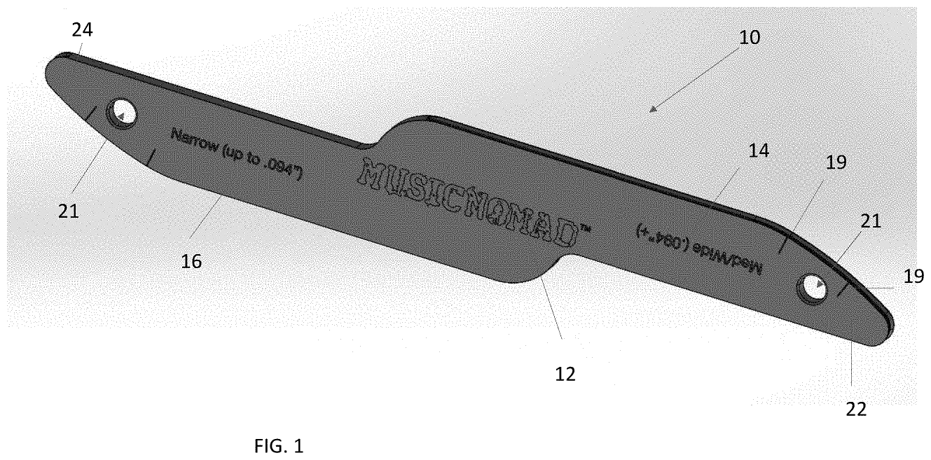

Referring to FIG. 1, in one embodiment, is a radiused fret crowning file 10. File 10 essentially comprises an elongated body 12 formed in the shape of an elongated S with a first arm 14 and a second arm 16 that extend relative to one another in spaced, parallel relation. A first slot 18 is formed in the outside edge of first arm 14 and a second slot 20 is formed in the outside edge of second arm 16. The majority of slots 18, 20 extend along longitudinal axes A-A and B-B, respectively, which are in spaced parallel relation to one another. The slots 18, 20 each continue to extend outwardly at an oblique angle from axes A-A and B-B, respectively, and terminate in a rounded nose 22, 24, respectively. The benefit of the tapered nose is to ergonomically assist in spot filing. Sometimes the user has completed 95% of the fret/metal strip but still have one little spot that needs to be shaped, and the taper lets the user easily roll up on the nose and file that exact spot. Lines 19 on the file that are vertical to the filing plane show exactly where the user are filing. The slots 18, 20 can be formed in whatever shape is desired for the filing, most typically a concave shape with a radius. A hole/holes 21 can be formed in one or each end of arms 14/16 to permit hanging of the file when not in use.

Slots 18, 20 each include first and second side regions 26, 28 and 30, 32, respectively, that extend from the outside edge of the slots towards the center of the slots. A crown region 34 and 36 extends along the center of slots 18 and 20, respectively, which is also the deepest part of the slots. Side regions 26, 28 and 30, 32 are coated with an abrasive grit, such as diamond or carbide dust, suitable for filing metal. Crown regions 34 and 36, by contrast, are left uncoated or have a smooth, non-abrasive coating such that no filing can occur in that region.

In use, the user would place a fret/metal strip in a slot 18 or 20 and then move the file 10 back and forth to file away material of the fret/metal strip until it is properly crowned and sized. The uncoated crown regions 34 or 36 prevents the fret from becoming over-filed as once the file 10 has removed the appropriate amount of material from the fret, the crown regions 34 or 36 will contact the fret/metal strip. Because the crown region is uncoated and/or smooth it will not remove any more material from the fret, thereby preventing the fret/metal strip from being over-filed.

The two slots 18, 20 are of different widths so as to accommodate differently sized frets. One of the slots is sized for narrow frets (up to 0.094″) while the other is sized for Med/Wide (0.094″+) frets.

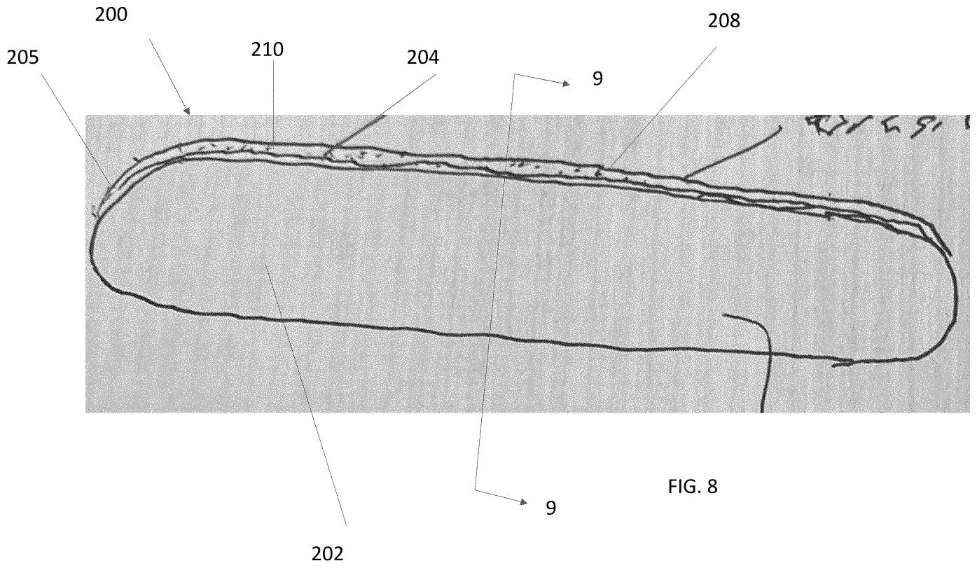

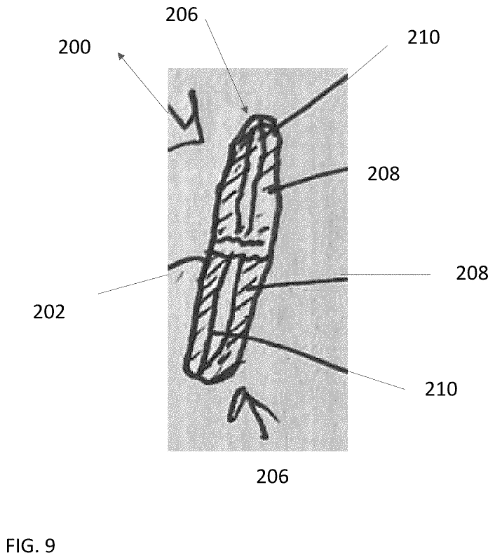

While the primary purpose of the file is to file frets of a stringed instrument, it could be used to file metal strips in virtually any other application. In addition, although the preferred embodiment shows the file 10 as having two arms 14 and 16, the file could simply be a single file having the slot with abrasive on the two sides and the uncoated crown region. For example, the file 200 shown in FIGS. 8-9 includes a linear body 202 with a first filing edge 204 that can include a rounded nose 205 and also includes a second filing edge 206 on its opposite side, but could be formed with only a single filing slot. As with file 10, file 200 includes abrasive sides 208 and a non-abrasive center srip.crown 210.

To manufacture file 10, it could largely be done in the same fashion as currently available files, but the sides 18, 20 would be interrupted by a center safety strip. This could be accomplished by machining channels into the radius of the file (sides 26, 28 and 30, 32), leaving the center step (crown region 34 and 36) untouched. This would allow space to coat the channels (sides 26, 28 and 30, 32) with diamond cutting material (or other material or cutting teeth directly into the material), leaving a constant radius of cutting material, interrupted in the crown portion by the safety strip. The crown portion can be flat, slightly channeled, concave or radiused, but it must not have any cutting material on it. The shape of the crown portion is not critical. The cutting material must extend from the sides of the crown portion down the sides/radius of the file.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A file for use in filing a strip of metal, comprising:
a. an elongated body having a first filing edge that extends along a first longitudinal axis; and
b. a first filing slot formed in the first filing edge and comprising a pair of edges that extend along the intersection of the first filing slot and the elongated body, a crown portion having first and second sides and that is positioned along the longitudinal axis and at the deepest portion of the first filing slot, and first and second side portions that extend from the first and second sides of the crown portion, respectively, to the respective edges of the first filing slot;
c. wherein the first and second side portions contain an abrasive material adapted for filing the strip of metal and the crown portion does not include abrasive material thereon.

2. The file according to claim 1, wherein the first filing slot is concave in shape.

3. The file according to claim 1, wherein the first filing slot extends at a first oblique angle outwardly from the first longitudinal axis and terminates in a first rounded nose.

4. The file according to claim 1, wherein the elongated body further comprises:
a. a second filing edge that extends along a second longitudinal axis, and a second filing slot formed in the second filing edge and comprising a pair of edges that extend along the intersection of the second filing slot and the elongated body, a crown portion having first and second sides and that is positioned along the second longitudinal axis and at the deepest portion of the second filing slot, and first and second side portions that extend from the first and second sides of the crown portion, respectively, to the edges of the second filing slot;
b. wherein the first and second side portions are coated with abrasive material adapted for filing the strip of metal and the crown portion does not include abrasive material thereon.

5. The file according to claim 4, wherein the first longitudinal axis and second longitudinal axis are in spaced parallel relation to one another.

6. The file according to claim 4, wherein the first filing slot and second filing slot are of predetermined widths that are different from one another.

7. The file according to claim 4, wherein the second filing slot extends at a second oblique angle from the second longitudinal axis and terminates in a second rounded nose.

8. A method for using a file to file a strip of metal, comprising the steps of:
a. providing a file having a filing slot that includes two sides of filing material coating formed thereon and a central, crown portion that is uncoated;
b. sliding the file back and forth across the strip of metal; and
c. stopping the sliding movement once the central, crown portion touches the strip of metal.

9. A file for filing a strip of metal, comprising:
a. a body with a first slotted filing region of predetermined depth formed therein and having a first crown portion at its deepest part and first and second radiused side regions extending outwardly from the first crown region; and
b. abrasive material formed on each of the first and second radiused side regions and non-abrasive material forming the first crown portion.

10. The file according to claim 9, wherein the filing region is concave in shape.

11. The file according to claim 9, further comprising:
a. a second slotted filing region of predetermined depth formed in the body and having a second crown portion at its deepest part and third and fourth radiused side regions extending outwardly from the second crown region; and
b. abrasive material formed on each of the third and fourth radiused side regions and non-abrasive material forming the second crown portion.

12. The file according to claim 11, wherein the first and second slotted filing regions are or predetermined width that are different from one another.
